(19) United States
(12) Patent Application Publication
(10) Pub. No.: US 2022/0412667 A1
(43) Pub. Date: Dec. 29, 2022

(54) THERMAL ENERGY STORAGE

(71) Applicant: SummerHeat Group B.V., Rotterdam (NL)

(72) Inventor: Joost Herman Jan BRAND, Amsterdam (NL)

(21) Appl. No.: 17/781,305

(22) PCT Filed: Dec. 2, 2020
(86) PCT No.: PCT/NL2020/050754

§ 371 Date: May 31, 2022

(30) Foreign Application Priority Data
Dec. 2, 2019 (NL) 2024355
Dec. 2, 2019 (NL) 2024357
Dec. 2, 2019 (NL) 2024361

(51) Int. Cl. F28D 20/00; F26B 21/00

(52) U.S. Cl. CPC F28D 20/0043; F26B 21/006

(57) ABSTRACT

A thermal energy storage system is provided, comprising an outer shell defining an outer shell volume, an energy transfer module, comprising an input port for providing energy to the energy storage system, an output port for retrieving energy from energy storage system, wherein the outer shell is provided with a fluid distribution network.

### FIELD OF THE INVENTION

The invention relates to thermal energy storage, such as seasonal thermal energy storage, and/or a method for manufacturing assembling a thermal energy storage and/or a method for storing electrical and thermal energy in a thermal energy storage system and/or a method for retrieving electrical and thermal energy from a thermal energy storage system.

### BACKGROUND

Thermal, e.g. seasonal, energy storage is known per se. Excess thermal energy at one moment, e.g. in one season, is stored for use at another moment, e.g. in another season. A common example is harvesting of to excess thermal energy in summer, e.g. using solar collectors, for heating a storage volume of water, and reusing thermal energy stored in the water during fall and winter, e.g. for heating a residence. It will be clear that a seasonal energy storage system requires sufficient capacity of storing heat to allow reuse of excess heat in one season to be used in another season. Preferably, the seasonal energy storage system has sufficient capacity to allow useful heat use up to at least three months, preferably four, five or six months, after storage of the heat. Hence, thermal energy stored during summer, e.g. up to September, can be used up to December-March.

WO2016020893A1 discloses a hot water storage tank which is erected from modular sidewall panels. The bottom edges of the panels are located in a rectangular base constructed from upwardly facing channels. The upright corners are reinforced by angle sections which are connected across the sidewalls by straps.

### SUMMARY

It is preferred to provide a thermal, e.g. seasonal, energy storage which may be easier to construct, may provide better storage of thermal energy, for example by reducing heat loss to the environment, and/or allow more energy to be stored in the thermal energy storage. It is further preferred to provide an underground thermal energy storage system.

According to a first aspect is provided a thermal energy storage system, comprising an outer shell defining an outer shell volume for holding a volume of fluid, an energy transfer module, comprising an input port for providing energy to the energy storage system, and an output port for retrieving energy from energy storage system, wherein the outer shell comprises a plurality of plate elements, and a plurality of perimeter elements interconnected or interposed between the plate elements.

The thermal energy storage system can be arranged as a seasonal energy storage system. Such structure of the thermal energy system provides particular advantages with respect to ease of manufacture, ease of construction, as well as thermal insulation, as will be described below.

The plate elements and the plurality of perimeter elements are preferably thermally insulating. The plate elements and the plurality of perimeter elements may as such provide an R-value of, sorted in order of preference, at least 0.2 m·K/W, at least 0.3 m·K/W, at least 0.4 m·K/W, preferably at least 0.8 m·K/W, even more preferably at least 5 m·K/W, even more preferably at least 15 m·K/W, or even more preferably at least 20 m·K/W, 25 m·K/W or more, 30 m·K/W or more, 40 m·K/W or more, or even 50 m·K/W or more.

The perimeter elements being interconnected or interposed between the plate elements, provide the advantage that the perimeter elements together with the wall elements can form a continuous wall of the outer shell. The continuous wall provides the advantage that thermal leakage can be minimised, especially when both the plate elements and the perimeter elements are thermally insulating to form a thermally insulating wall. Forces exerted on the outer shell may be guided through the plate elements and the perimeter elements. As such, a high stiffness outer shell may be obtained, which for example may be placed underground and is arranged to withstand pressure from ground surrounding the outer shell and placed on top of the outer shell.

In examples, a perimeter element may be formed by a plurality of sub-elements. Similarly, a plate element may be formed by a plurality of sub-elements.

Each perimeter element abuts or at least some of the perimeter elements abut against at least one plate element. The abutment surface of the perimeter element can have a shape complementary to a shape of the abutment surface of the plate element. Preferably, the complementary abutment surfaces have an interlocking shape. Hence, thermal leakage can be minimised and/or a strong and stiff outer shell can be obtained.

The abutment surfaces can generally extend substantially in a direction perpendicular to an outer face of the outer shell. Hence, compressional or expansional forces to the outer shell do not work to open a seam at the abutment surfaces.

Energy may be stored in the thermal energy storage by virtue of thermal energy stored in a fluid, such as water. By storing thermal energy in the fluid, the temperature of the fluid may be increased. By retrieving thermal energy from the thermal energy storage system the temperature of the fluid may be lowered.

Energy storage may be preferred when there is an offset between times where energy is available, and when energy is required. For example, photovoltaic, PV, panels can supply more energy in the summer, while energy required for heating a building is required in the winter. Also on a smaller time scale an offset may be present; for example can PV panels only supply energy by virtue of solar irradiation, while energy demand may be at night.

It may thus be preferred to store energy, for example thermal energy, in the energy storage system for a small amount of time, e.g. a day, and/or for a longer amount of time, e.g. multiple days or months, or e.g. during a winter and/or autumn.

Depending on the amount of thermal energy that is to be stored in the thermal energy storage system, a volume of fluid and thus the volume of the energy storage system may change. An energy storage system for storing thermal energy during one or a couple of days may hence require a smaller volume than an energy storage system for storing thermal energy during a couple of months. An energy storage system for a single dwelling may hence require a smaller volume than an energy storage system for a larger office building or a group of houses.

Examples of the energy storage system may be arranged as an underground energy storage system. This may for example imply that the outer perimeter of the energy storage system, for example formed by the outer shell, is arranged to be exposed to moist soil for a significant amount of time, for example in the order of multiple years or decades.

Soil may be defined as any substrate or ground type, earth, dirt, mud, rock, gravel, crushed recycled concrete, clay, sand, any other material in which an object may be buried or any combination thereof. Soil may be temporally displaced to create a hole or volume in which an underground energy storage system can be placed. Part of the displaced soil may be placed back on top and/or around at least part of the underground energy storage system.

In examples of the outer shell, plate elements do not fully extend to edges of the outer shell. Instead, on the edges, perimeter elements are provided. As such, in examples, plate elements do not overlap one another.

The plurality of plate elements and perimeter elements may form a substantially rectangular shape, wherein one or more of the edges and corners of the substantially rectangular shape are non-straight edges and corners.

Substantially rectangular may imply that the general shape of the energy storage system resembles a rectangle. Substantially rectangular may also imply that plate elements are provided either substantially parallel or substantially perpendicular to one another.

An edge or corner may be non-straight when it is chamfered, beveled, rounded off, or has any other shape such that the edge or corner is substantially not perpendicular. As such, a faceted substantially rectangular shaped outer shell may be obtained.

The ratio between a circumferential distance spanned by two perimeter elements and the plate elements interconnecting the two perimeter elements may be larger than 1%, larger than 3%, larger than 5%, larger than 10%, larger than 15%, larger than 20%, or even larger than 25%, for example larger than 30% or even larger than 40%. The ratio may for example depend on the number of plate elements interconnecting the two perimeter elements, and the size of the plate elements and the perimeter elements.

When many or all of the plate elements, corner elements and/or edge elements are substantially identical, a modular outer shell may be obtained. Such a modular outer shell may easily be adapted to accommodate a different volume of fluid, for example dependent on a desired energy storage capacity of the energy storage system.

In a preferred example of the energy storage system, at least 90% of the plate elements are substantially volumetrically identical. More preferably, at least 95% of the plate elements are substantially identical, and even more preferably, all plate elements are substantially identical. Plate elements may be substantially identical if they are manufactured using the same or a similar mould, or by using the same or similar manufacturing steps, such as a sequence of milling operations.

The plurality of perimeter elements may comprise one or more edge elements, and/or one or more corner elements.

In a preferred example of the energy storage system, at least 90% of the edge elements are substantially volumetrically identical. More preferably, at least 95% of the edge elements are substantially identical, and even more preferably, all edge elements are substantially identical. Edge elements may be substantially identical if they are manufactured using the same or a similar mould, or by using the same or similar manufacturing steps, such as a sequence of milling operations.

In a preferred example of the energy storage system, at least 90% of the corner elements are substantially volumetrically identical. More preferably, at least 95% of the corner elements are substantially identical, and even more preferably, all corner elements are substantially identical. Corner elements may be substantially identical if they are manufactured using the same or a similar mould, or by using the same or similar manufacturing steps, such as a sequence of milling operations.

Furthermore, when many or all of the plate elements, corner elements and/or edge elements are substantially identical, the outer shell may be easier to construct and/or the manufacturing process of the elements comprised by the outer shell may be more economical.

The outer shell may comprise a tensioning module arranged to tension the plurality of interconnected perimeter elements and plate elements towards each other. The tensioning module may for example be arranged as a set of tension bands provided under a pre-tension to hold the elements comprised by the outer shell together. Also soil pressure can be used to pretention. This may reduce the number of other pretensioning modules. Furthermore, the pre-tensioning may increase the strength and/or stiffness of the outer shell.

Examples of the thermal energy storage system may comprise a liner module within the outer shell arranged for holding the volume of fluid in the outer shell. The liner module can provide the advantage that fluid tightness for holding the volume of fluid in the outer shell can be provided by the liner module. Hence, the outer shell itself need not be fluid tight.

The liner module may be arranged to prevent contact between the fluid inside the outer shell and the outer shell itself. The liner module may further be arranged to provide thermal and/or electrical insulation between the fluid in the outer shell and the outer shell itself.

The liner module may in examples comprise an inner liner element, and an outer liner element, surrounding at least part of the inner liner element, wherein the inner liner element may be arranged for containing the second volume of fluid. When the fluid is a liquid such as water, the inner liner element can be liquid-tight, such as watertight. The outer liner element may be arranged to constrain the volume of the inner liner element. The outer liner element can e.g. have a high stretch resistance. When the inner liner element has a high elongation at break, and the outer liner element has a high stretch resistance, the combined inner and outer liner elements can be very resistant against rupture, especially in the long term, for example for multiple years or decades even.

When an example of a thermal energy storage system comprises an outer shell, at least part of an inner surface of the outer shell may be provided with a plurality of ridges. When the thermal energy storage system includes the liner module, the liner module can abut against the ridges. When the liner module has a high stretch resistance, the liner module may be prevented from sinking between the ridges, as will be explained in more detail below.

Examples of the thermal energy storage system may comprise an inner shell defining an inner shell volume within the outer shell volume, and arranged for holding a volume of fluid. As such, a shell-in-a-shell may be obtained, wherein the inner shell is isolated from the environment first by fluid provided in the outer shell and then by the outer shell itself. The inner shell may as such be arranged for storing fluid with a higher or different temperature or range of temperatures than the fluid in the outer shell. The inner shell may be provided in the liner module. The inner shell may provide the advantage that fluid can be stored in, or at least he collected from, the thermal energy storage at different temperatures for different uses.

When an example of a thermal energy storage system comprises an inner shell, the energy transfer module, e.g. the output port, may be provided in fluid connection with the inner shell volume at a first depth and a second depth, which second depth may in use be lower than the first depth.

The inner shell may be provided inside or outside the outer shell, and the inner shell may be provided inside or outside the liner module. The inner shell may be placed substantially in the centre of the outer shell, or near or at an edge or corner of the outer shell.

When the second depth is lower than the first depth, by virtue of stratification, a fluid temperature at the first depth may be higher than a fluid temperature at the second depth. In use, the fluid at the first depth may be used for different purposes than the fluid at the second depth due to this temperature difference. For example may the fluid at the first depth he used for heating water for cooking, washing, and/or showering, and fluid at the second depth may be used for heating a building, for example using radiators or underfloor heating.

The energy transfer module, for example the input port and/or the output port, may be provided in fluid connection with the outer shell volume at a third depth. In use, the third depth may be different or substantially the same as the first depth and/or the second depth.

Examples of the energy storage system may comprise a fluid transfer module for allowing fluid transfer between an upper part of the volume of fluid outside the inner shell volume and a lower part of the volume of fluid inside the inner shell volume when the energy storage system comprises an inner shell. The volume of fluid outside the inner shell volume may for example be the outer shell volume.

By virtue of the fluid transfer module, a forced fluid flow may be constituted between the outer shell volume and the inner shell volume, in particular between an in use upper part of the volume of fluid outside the inner shell volume and a in use lower part of the volume of fluid inside the inner shell volume. Such a fluid flow may be preferred when a temperature of fluid in the upper part of the outer shell volume is higher or equal to a temperature of fluid in the lower part of the inner shell.

To provide thermal insulation between the liner module or fluid contained within the liner module and the outer shell, examples of the energy storage system may comprise a radiation barrier provided between the liner module and the outer shell. In particular, the radiation barrier may be comprised by the liner module. It has been found that the radiation harrier can aid in preventing radiation losses of the volume of fluid. Preventing radiation losses is particularly useful when the temperature of the stored fluid is elevated, such as above 40 degrees, above 60 degrees, or even above 80 degrees centigrade. The thermal energy storage system wherein the outer shell comprises a plurality of plate elements, and a plurality of perimeter elements interconnected or interposed between the plate elements is particularly useful for storing a fluid, such as water, at elevated temperatures of 40 degrees or more, 60 degrees more, or even 80 degrees centigrade and higher.

According to a second aspect a method is provided for assembling a thermal energy storage system, for example according to the first aspect. The method comprises the steps of building the outer shell by interconnecting plate elements and perimeter elements, optionally providing the liner module in the outer shell and optionally positioning the inner shell inward of the outer shell.

The first step of the method according to the second aspect of building the outer shell by interconnecting plate elements and perimeter elements may be performed in more than one intermediate steps, wherein in-between these intermediate step the second and/or third step of the method may be performed.

According to a third aspect a thermal, e.g. seasonal, energy storage system is provided, comprising an outer shell defining an outer shell volume, an energy transfer module, comprising an input port for providing energy to the energy storage system, an output port for retrieving energy from energy storage system, wherein the outer shell is provided with a fluid distribution network.

By virtue of the fluid distribution network, moisture may be withdrawn from the outer shell, which moisture may negatively impact thermal insulation properties of the outer shell. The moisture may e.g. be withdrawn by ventilation, such as natural or forced ventilation. Moisture may enter the outer shell via at least part of an outer surface of the outer shell, which may be placed in moist ground when the energy storage system is, in use, placed underground. Also, moisture contained in air may condensate onto the inner surface and/or outer surface of the outer shell due to temperature differences in use between the ground, outer shell and the fluid inside the energy storage system.

For example, when it is preferred to store thermal energy in the thermal energy storage system for a long time, e.g. one or more months or during a winter, withdrawing moisture from the outer shell may increase the time over which the thermal energy can be stored within the system by preventing or reducing the negative impact of the moisture on the thermal insulation properties of the outer shell.

Furthermore, when it is preferred to use the energy storage system for a long period of time, for example five or more or even 25, 50 or more years, withdrawing moisture from the outer shell may increase the longevity of the energy storage system.

The energy transfer module may be arranged for providing a fluid flow through the fluid distribution network of the outer shell, which fluid flow may comprise matter in liquid state, gas state or a mix thereof. For example may the fluid flow comprise air with a particular moisture content.

When an example of an energy storage system comprises a liner module, the energy storage system may comprise a plurality of ridges and grooves provided along at least part of an inner surface of the outer shell and at least part of an outer surface of the liner module may be arranged to abut the ridges. As such, the space enclosed by the grooves and the liner module may form part of the fluid distribution network. In the space enclosed by the grooves and the liner module, a fluid flow, typically ventilation air from the dwelling, may be constituted which may withdraw moisture from the outer shell and/or the liner module.

The ridges may be oriented substantially parallel to each other. In other examples, a first group of ridges is parallel to each other, a second group of ridges is parallel to each other, and the ridges of the first group are substantially perpendicular to the ridges of the second group or are provided at a particular angle relative to the ridges of the second group. As such, a particular pattern of ridges may be obtained which may be optimised to provide an efficient flow path for withdrawing moisture from the outer shell using the fluid flow.

The outer shell may comprise a plurality of passages through the outer shell, which plurality of passages may form part of the fluid distribution network along the outer shell. With the plurality of passages, at least part of the fluid distribution network may be provided through the outer shell, and moisture may be withdrawn from within the outer shell.

When the outer shell comprises a plurality of plate elements, at least some of the plate elements may comprise a slotted passage as part of the plurality of passages through the outer shell. Slotted passages may be provided in the plate elements such that when moisture enters the outer shell via its outer surface, at least part of the moisture, and preferably substantially all of the moisture has to pass through a slotted passage, where it may be withdrawn from the outer shell by virtue of the fluid flow through the fluid distribution network.

According to a fourth aspect a thermal, e.g. seasonal, energy storage system is provided, comprising an outer shell defining an outer shell volume for holding a volume of fluid, an energy transfer module, comprising an input port for providing energy to the energy storage system, an output port for retrieving at least thermal energy from energy storage system, wherein the energy transfer module further comprises an energy conversion module for converting between chemical energy of fluid stored in the energy storage system and electrical energy, and the energy storage system further comprises a second output for retrieving electrical energy from the energy storage system. The inventors found that the fluid, such as a liquid, such as water, used for storing thermal energy, can efficiently also be used for storing the chemical energy. Especially, when the thermal storage system uses a large volume of fluid, also a large volume of fluid is available for storing the chemical energy. The storage of chemical energy may be performed without the phase of the fluid in which the energy is stored changing and/or without storing energy as latent heat.

With a thermal energy storage system according to the fourth aspect, chemical energy may be stored in the thermal energy storage system in addition to thermal energy. The chemical energy is converted by the energy conversion module from electrical energy, which may for example be supplied by PV-panels or wind turbines. By using the fluid inside the energy storage system for storing thermal energy as well as chemical energy, a higher energy density may be obtained. Furthermore, whereas thermal energy may leak away out of the energy storage system into the environment, chemical energy may be sustainably stored for a longer period of time, for example one or more months, more than a winter period, or even multiple years.

Examples of the thermal energy storage system may be arranged for containing three separate volumes of fluid. For example, a plurality of separate volume containers may be provided, such as one or more liner modules. It may be preferred to prevent mixing of different types of fluids in the storage system. If different types of fluid were allowed to mix, chemical energy may be inadvertently converted into thermal energy or any other undesired chemical reaction may occur which may deplete the storage or at least lower the amount of chemical energy stored.

When the energy storage system is arranged for containing three separate volumes of fluid, the storage system may further comprise a control system arranged to change the volume ratio between the three separate volumes of fluid, for example by using a plurality of pumps and conduits between the three separate volumes.

The energy conversion module may be arranged for receiving a first fluid flow of first fluid, a second fluid flow of second fluid, and arranged to mix the fluid flows into a third fluid flow. With the mixing of the first fluid flow and second fluid flow into a third fluid flow, chemical energy may he converted into electrical energy and/or thermal energy, or the other way around, depending on the type of fluid comprised by the first and second fluid flow.

The energy conversion module may be arranged for receiving a third fluid flow of third fluid, and to separate the third fluid flow into a first fluid flow of first fluid and a second fluid flow of second fluid. With the separation of the third fluid flow into the first fluid flow and second fluid flow, electrical energy may be converted into chemical energy and/or thermal energy, or the other way around, depending on the type of fluid comprised by the third fluid flow.

In examples, the energy storage system may be arranged for containing two separate volumes of fluid. When the energy conversion module comprises a membrane, the membrane may be arranged for transferring ions between the two separated volumes of fluid.

For holding separated volumes of fluid, examples of the energy storage system comprise a plurality of liner modules and/or a plurality of inner shells. As such, a plurality, for example two or three, separate volumes may be contained within the energy storage system.

The inner shell may comprise an inner shell separator for separating a first inner shell volume from a second inner shell volume, such that two separated volumes may be contained within the energy storage system.

According to a fifth aspect a method is provided for storing electrical and thermal energy in a thermal energy storage system, in particular according to the fourth aspect. The method comprises the steps of via an input port of the energy storage system, providing or supplying thermal energy to a fluid inside the energy storage system via an input port of the energy storage system, providing electrical energy to an energy conversion module, and using or by the use of the energy conversion module, converting the provided electrical energy into chemical energy in the fluid in the energy storage system.

With the method according to the fifth aspect, the energy storage system may be charged with electrical and thermal energy. In particular, the method may comprise converting the provided electrical energy into chemical energy in the same fluid in the energy storage system as the thermal energy is stored.

According to a sixth aspect a method is provided for retrieving electrical and thermal energy from a thermal energy storage system, in particular according to the fourth aspect. The method comprises the steps of via an output port of the energy storage system, retrieving thermal energy from a fluid inside the energy storage system, and providing a fluid from the energy storage system to an energy conversion module, and, using the energy conversion module, converting chemical energy of the fluid into electrical energy.

With the method according to the sixth aspect, the energy storage system may be discharged by withdrawing electrical and/or thermal energy. In particular, the method may retrieving thermal energy from the same fluid used for converting chemical energy of into electrical energy.

According to a seventh aspect a method is provided for creating an underground thermal energy storage system, comprising providing a thermal energy storage system according to any of the disclosed examples. placing the energy storage system underground, and substantially surrounding the energy storage system with soil.

It will be appreciated that all aspects, features and options mentioned in view of the systems apply mutatis mtutandis to the methods, and vice versa. It will also be clear that any one or more of the aspects, features and options described herein can be combined.

### DESCRIPTION OF THE FIGURES

FIG. 1 shows a partially opened view of a dwelling as an example of a building, connected to an example of a seasonal energy storage system;

FIG. 2 shows a partially opened view of a dwelling as an example of a building, connected to another example of a seasonal energy storage system;

FIG. 3 shows a partially opened up view of an example of a seasonal energy storage system;

FIG. 4 shows an exploded view of part of an example of an outer shell of a seasonal energy storage system;

FIG. 5A shows an example of an edge element;

FIG. 5B shows an example of a corner element;

FIG. 6 shows a schematic cross-section of an example of the energy storage system;

FIG. 7A shows a quarter section of an embodiment of an outer shell of the energy storage system;

FIG. 7B shows a detail of FIG. 7A;

FIG. 8 shows a cross-section of part of an example of an outer shell;

FIG. 9A and FIG. 9B schematically show an example of an energy storage system;

FIG. 10A depicts another example of an energy storage system;

FIG. 10B depicts the example of FIG. 10A in a partially opened-up view;

FIG. 11A shows an exploded view of part of an energy storage system; and

FIG. 11B shows another view of the exploded view of FIG. 11A.

### DETAILED DESCRIPTION

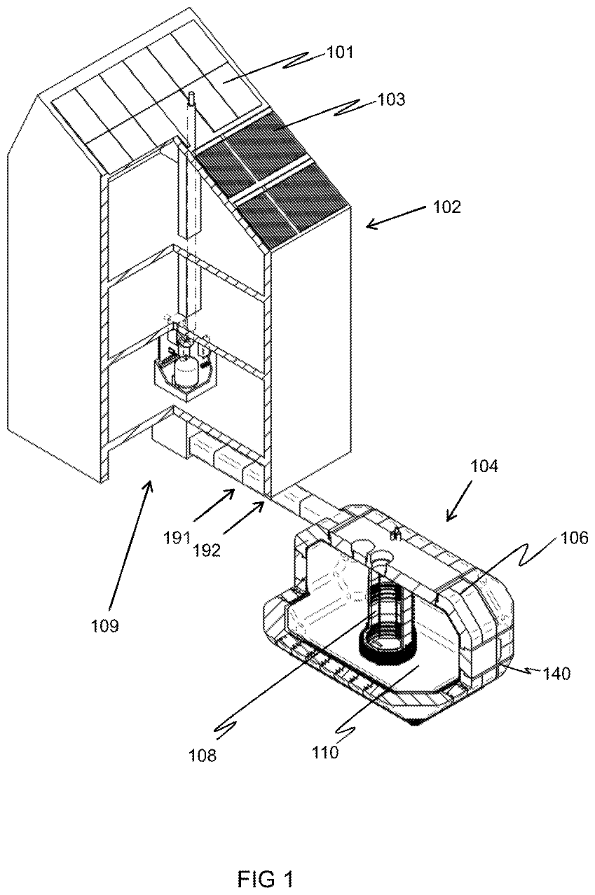

FIG. 1 shows a dwelling 102 as an example of a building, connected to an example of a thermal energy storage system 104. In this example, the thermal energy storage system 104 is a seasonal energy storage system. The dwelling 102 is provided with photovoltaic, PV, panels 101 and solar collectors 103 as energy sources for, respectively, electrical energy and thermal energy.

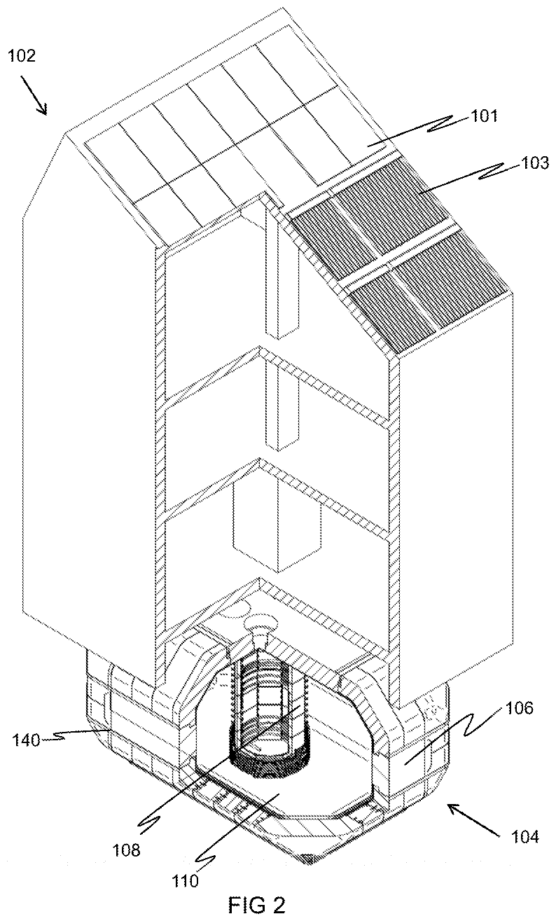

The thermal energy storage system 104 is in FIG. 1 shown substantially not directly below the dwelling 102. As such, the thermal energy storage system 104 may be provided to the dwelling 102 after the dwelling 102 itself has already been constructed, for example in or under an adjacent garden. FIG. 2 shows a thermal energy storage system 104 provided substantially below dwelling 102. The arrangement of FIG. 2 may require the thermal energy storage system 104 to be built and placed prior to constructing the dwelling 102.

In examples, the thermal energy storage system 104 is arranged to be placed at least partially under ground, or even entirely under ground. This may cause weight of surrounding soil to create a pressure onto the energy storage system 104. To withstand this pressure, for example over the total lifespan of the storage system, which may be at least 10 years, or even more than 30 years, it may be preferred to prevent peak stresses in the outer shell and instead guide stresses through the entire outer shell by virtue of the plurality of perimeter elements interconnected or interposed between the plurality of plate elements.

Schematically indicated in FIG. 1 is an energy transfer module 109. Here, the energy transfer module 109 includes an input port 191 and an output port 192. Any part of the energy transfer module 109, e.g. input port 191 and/or output port 192, may be partially or completely outside the outer shell and/or may be arranged to at least partially be provided inside the dwelling 102.

The examples of the thermal energy storage system 104 as shown in FIGS. 1 and 2 comprise an outer shell 106, defining an outer shell volume. Provided inside the outer shell is an inner shell 108 defining an inner shell volume. In these examples, provided inside the outer shell 106 is an optional liner module 110, and the inner shell 108 is provided inside the liner module 110.

In other examples of the thermal energy storage system 104, the inner shell 108 and/or the liner module 110 is not required nor provided.

The outer shell 106 may be provided with a tensioning module 140, arranged for providing a tensioning force around the outer shell 106, for example to counter a pressure of fluid inside the outer shell 106 pushing or exerting pressure outwardly from the inside the outer shell 106 and/or increasing vertical load capacity.

In use, the inner shell 108 may be used for storing the highest temperature fluid, and the outer shell 106, or the liner module 110, may be used for storing lower temperature fluid. The surroundings of the thermal energy storage 104, for example ambient air or soil, are likely to have a temperature lower than the fluid temperature in the outer shell 106 or liner module 110. As such, the fluid inside the outer shell 106 or liner module 110 may act as a thermal barrier between the hot fluid inside the inner shell 108 and the surroundings outside the outer shell 106.

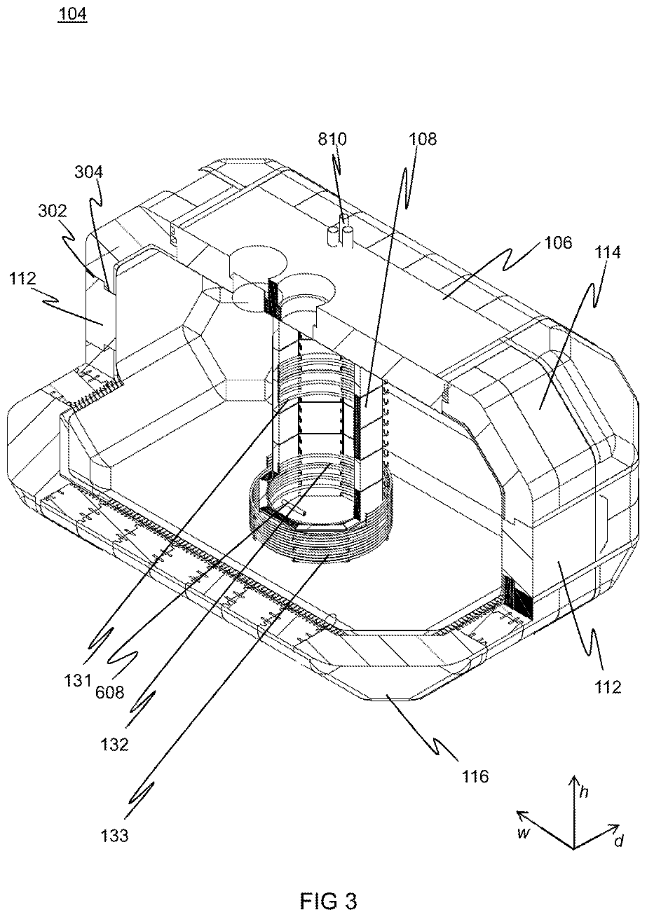

FIG. 3 shows a partially opened up view of an example of a thermal energy storage system 104, wherein the outer shell 106 comprises a plurality of plate elements 112 and a plurality of perimeter elements 114, 116. Here the perimeter elements are formed by edge elements 114 and corner elements 116. The edge elements 114 are interconnected between the plate elements 112. Here the corner elements 116 are interconnected or interposed between the edge elements 114.

The use of the perimeter elements 114, 116 interconnected or interposed between the plate elements, provides the advantage that a very strong structure for the outer shell 106 can be provided. The perimeter elements 114, 116 allow for a structure without seams directly at the edges and corners of the outer shell. The absence of such seams reduces the vulnerability of the outer shell to seams opening up under forced from the outside or inside of the outer shell.

The example of the thermal energy storage system 104 as shown in FIG. 3 comprises in a width direction w seven edge elements 114, in a height direction h two edge elements 114 and in a depth direction d three edge elements 114. In other examples, in any of the three directions, any other number of edge elements 114 may be used, such that energy storage systems with different sizes may be obtained. Because of this modularity of the plate elements 112, corner elements 116 and edge elements 114, a fluid capacity, and hence energy storage capacity, may be fine-tuned, for example to a specific yearly energy need of one or more buildings.

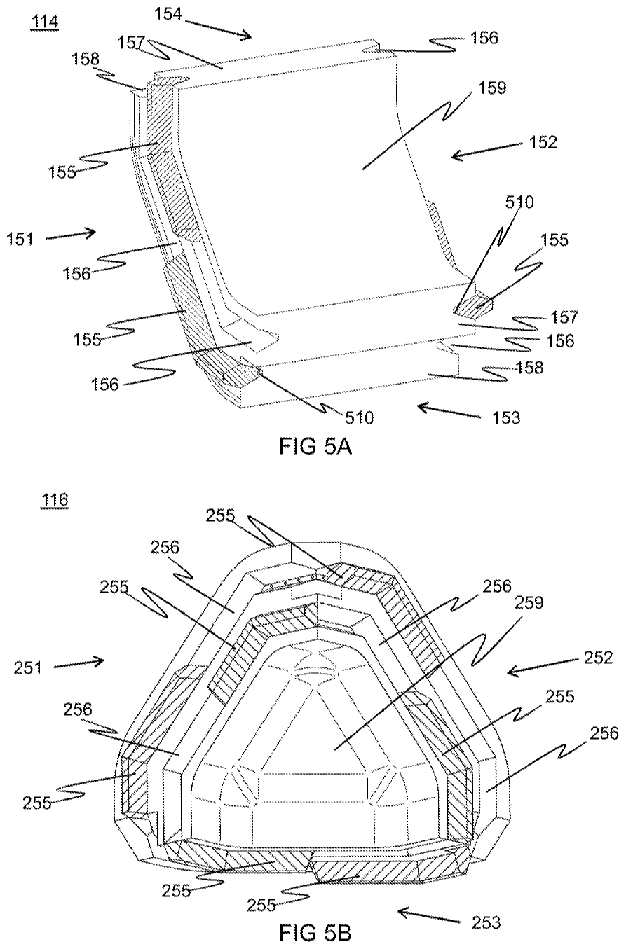

As can be seen in the examples of FIGS. 1-3, the edge elements 114 are interposed between the plate elements 112, and the corner elements 116 are interposed between the edge elements 114, such that corner elements 116 and edge elements 114 together with the wall elements 112 form a continuous wall of the outer shell 106. The elements 112, 114, 116 in these examples are thermally insulating. Here, the elements 112, 114, 116 are constructed from a foam material, such as polystyrene foam or polyurethane foam. Also can be seen that each edge element 114 abuts against at least one plate element 112, here against two plate elements 112. An abutment surface of the edge element 112 in these examples has a shape substantially complementary to a shape of the abutment surface of the plate element 112. Preferably, the complementary abutment surfaces have an interlocking shape, as for example explained below in relation to FIG. 5. Also can be seen that each corner element 116 abuts against at least one edge element 114, here against three edge elements 114. An abutment surface of the corner element 116 in these examples has a shape complementary to a shape of the corresponding abutment surface of the edge element 114, as for example explained below in relation to FIG. 5. Preferably, the complementary abutment surfaces have an interlocking shape.

The plate elements 112 as shown in FIG. 3 comprise a substantially T-shaped cross-section, which in other examples may also be a substantially X-shaped or +-shaped cross-section. Here, the plate elements 112 are provided with a recessed plate element plane 304 provided at a side of the plate element 112 facing into the outer shell volume, and an extended plate element plane 302 facing outwardly of the outer shell. The function of these planes will be discussed in conjunction with FIG. 5A.

In the example of FIG. 3, the energy storage system 104 is provided with an energy transfer module 109. The energy transfer module includes an input port 191 for providing energy to the energy storage system, and an output port 192 for retrieving energy from energy storage system 104. In this example, the energy transfer module 109 includes a first spiral 131, a second spiral 132, and a third spiral 133. Here, the first spiral 131 and the second spiral 132 are provided in the inner shell 108, such that, in use, the first spiral 131 is provided at a higher location with respect to gravity than the second spiral 132. Here, the third spiral 133 is provided outside the inner shell 108, preferably surrounding the inner shell 108.

By virtue of stratification of the fluid, such as water, in the inner and outer shells, different fluid layers may exists within the inner shell 108, wherein the different layers comprise fluid arranged according to density. Since the density of a fluid is related to its temperature, and a higher temperature may give a lower density, the temperature of fluid in higher layers may be higher than the temperature of fluid in lower layers.

In this example the first spiral 131 is arranged for extracting heat from the inner shell volume. The first spiral is positioned towards the top of the inner shell volume, where a higher temperature is to be expected. The first spiral 131 is connected to the output port 192. In this example, the second spiral 132 is arranged for providing heat to the inner shell volume. Thereto, here the second spiral is positioned towards the bottom of the inner shell volume, where a lower temperature is to be expected. In this example, the third spiral 133 is arranged for providing heat to the outer shell volume. Thereto, here the second spiral is positioned towards the bottom of the outer shell volume, where a lower temperature is to be expected. Here, a high temperature difference between the third spiral 133 and the fluid in the outer shell volume may be obtained which may increase the efficiency of transfer of thermal energy by virtue of conduction.

Although the example of the energy storage system 104 is shown with three spirals, examples are envisioned comprising any number of spirals. These spirals may be provided anywhere in the energy storage system 104, for example in the inner shell 108, outer shell 106, liner module 110, or in a combination thereof.

A spiral may be embodied as an electrical element such as a resistance, and as such the input port 191 may be provided with an electrical input port for receiving electrical energy. The electrical energy may be converted by the spiral into thermal energy, and this thermal energy may be used to increase the temperature of fluid inside energy storage system. A spiral may also be embodied as tubes, for allowing transport of fluid in and or out of the energy storage system.

Instead of or in addition to using spirals as part of the input port for providing energy to the energy storage system 104, heaters with a different shape than a spiral may be used. For example, any shape of tubular heating elements or in general any electric heater with a resistance heating element may be used for increasing the temperature of fluid inside the energy storage system 104.

As shown in FIG. 3, the outer shell 106 may have a substantially rectangular shape wherein one or more of the edges and corners of the substantially rectangular shape are non-straight edges and corners. In the particular example of FIG. 3, all edges and corners of the substantially rectangular shape are non-straight edges and corners. By having an outer shell 106 with non-straight edges and corners, normal forces on the outer shell 106 may be substantially converted into compression/tension forces and bending moment may thus be reduced or substantially prevented.

A non-straight edge or corner may be an edge or corner that is chamfered, notched, beveled, rounded, provided with a radius, such that an outer side of the edge or corner is not a corner or edge of 90 degrees.

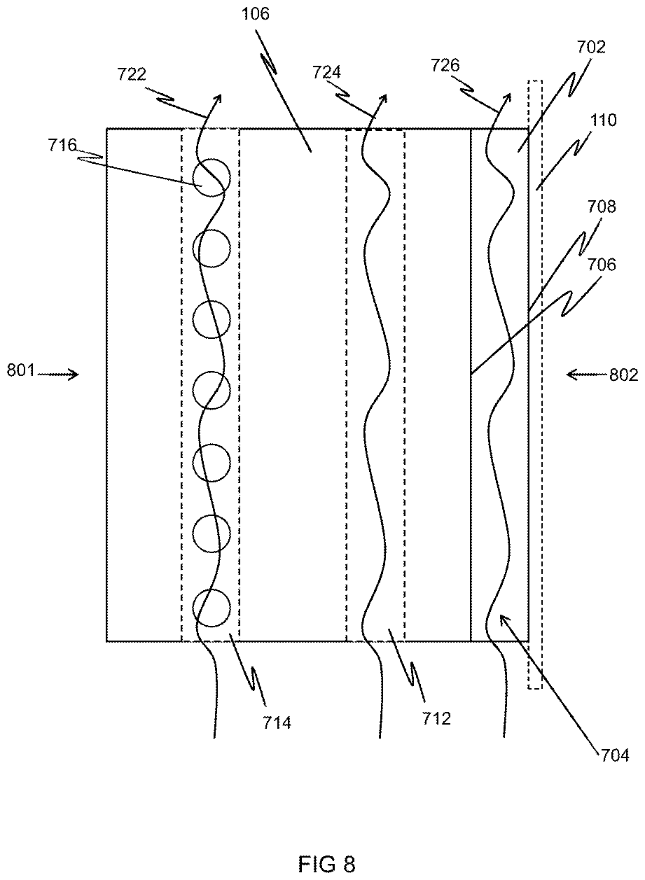

As an option, the example of the energy storage system 104 as shown in FIG. 3 comprises a ventilation port 810. The ventilation port 810 can be part of the energy transfer module 109, either as an input port 191, output port 192 or both. The ventilation port 810 may comprise one or more conduits, and may be connected to a fluid distribution network, which will be elaborated on in conjunction with FIG. 8.

Although many of the examples of energy storage system 104 shown in the figures depict non-straight edges and corners, it will be appreciated that examples of the energy storage system 104 may also be provided with some or all edges and corners as straight edges and corners.

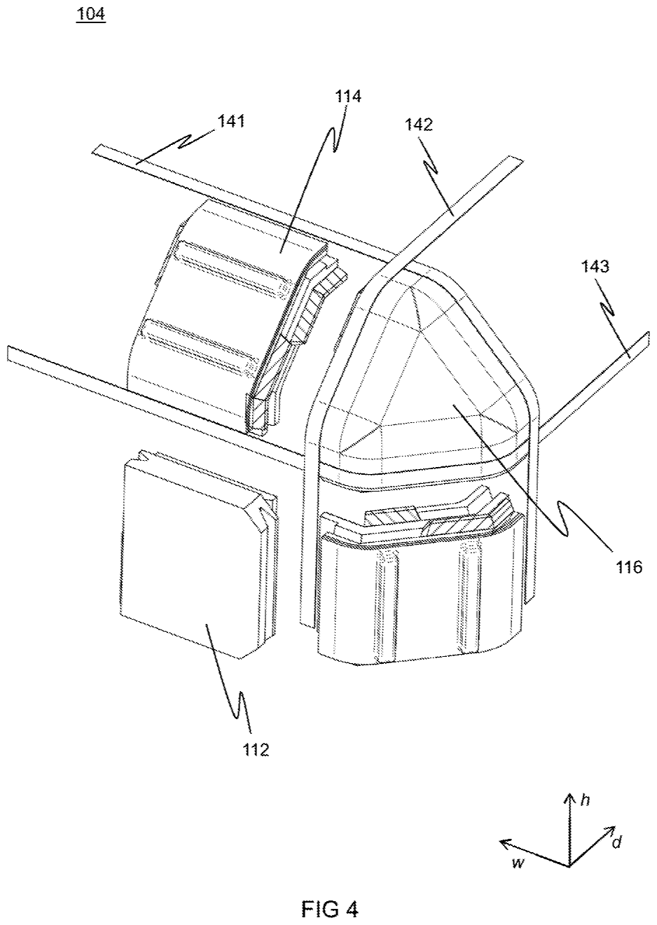

FIG. 4 shows an exploded view of part of an example of a seasonal energy storage system 104, with plate element 112, corner element 116, and two edge elements 114. FIG. 4 furthermore shows part of a first tensioning band 141, a second tensioning band 142 and a third tensioning band 143 as parts of a tensioning module 140 arranged to tension plate elements and perimeter elements comprised by the outer shell 106 towards each other.

The tensioning module 140 may be arranged as a set of bands, cables, ropes, elastic bands, belts, fibres, any other tensioning element or any combination thereof. The tensioning may be used to counter pressure of the fluid inside the storage system which exerts a pressure to push the interconnected plate elements and perimeter elements outwards and/or apart.

Furthermore, by virtue of the tensioning module 140 tensioning plate elements 112, corner elements 116 and edge elements 114 together, the strength and/or stiffness of the outer shell 106 may be increased. With the increased strength, the outer shell 106 may for example be able to withstand higher outside pressures, for example due to weight of soil pressing onto the outer shell 106.

The tensioning bands may be oriented such that tensioning is provided in three directions. These three directions are preferably substantially orthogonal, and e.g. substantially equal to respectively a width direction w, depth direction d, and height direction h of the outer shell 106. The tensioning bands may be guided over edges of corner elements 116.

FIG. 5A shows an example of an edge element 114. The edge element 114 is arranged to be interconnected with other perimeter elements such as edges elements or corner elements at a first side 151 and a second side 152. The edge element 114 is further arranged to be interconnected with plate elements at a third side 153 and a fourth side 154. An inner side of the edge element 114 which in use faces inwardly towards the energy storage system 104 is indicated with reference numeral 159.

At the first side 151 and the second side 152, the edge element 114 is provided with protrusions 155 and grooves 156. For clarity of the figure, the protrusions 155 are hatched. Due to the orientation of the figure, only three protrusions 155 are visible in FIG. 5A. The protrusions 155 are arranged to be inserted in to the grooves 156 of the adjacent edge element, and the grooves 156 are arranged to receive the protrusions 155 of the adjacent edge element. The number of grooves and/or protrusions is not limited to the three visible in FIG. 5A and may be any suitable number. The number of grooves may be equal or not equal to the number of protrusions.

At the third side 153 and the fourth side 154, the edge element 114 is provided with an extended edge element plane 157 and a recessed edge element plane 158. In this example, the extended edge element planes 157 are provided at the inner side of the edge element 114. When an extended plate element plane of a plate element abuts the recessed edge element plane 158, and a recessed plate element plane of the plate element abuts the recessed edge element plane 158, inward movement of the plate elements into towards the energy storage system 104 may be substantially prevented. This movement may be caused by an outside pressure pressing onto the outer shell 106, which may e.g. be caused by soil surrounding the outer shell 106.

To ease construction of an outer shell 106 comprising plate elements and perimeter elements, in this example the particular arrangement of protrusions 155 and grooves 156 of the example of the edge element 114 as shown in FIG. 5A is such that the edge element 114 is rotationally symmetric when rotated around an axis normal to the inner surface 159. In such an arrangement, the protrusions of the first side 151 and protrusions of the second side 152 are provided in different grooves 156, and do not overlap to allow the rotational symmetry.

FIG. 5B shows an example of a corner element 116. Here, the corner element 116 comprises six protrusions 255, of which two protrusion 255 are provided at a first side 251, two protrusions 255 are provided at a second side 252, and two protrusions 255 are provided at a third side 253. At each side, the corner element 116 comprises two grooves 256, arranged to receive a protrusion of the adjacent edge element. Per side, each groove 256 is partially filled with a protrusion 255. The protrusions 255 are arranged such that the corner element 116 is rotationally symmetrical around an axis normal to plane 259, which in uses faces into the outer shell 106. As such, the construction of the energy storage system 104 may be made more easy, as no specific orientation of the corner elements 116 is required.

It will be appreciated that examples of the corner element 116 are not restricted to two sets of grooves of the embodiment depicted in FIG. 5B, and may comprise any suitable number of grooves 256 and/or protrusions 255.

The corner element 116 is arranged to be interconnected with three edge elements 114, one at the first side 251, one at the second side 252 and one at the third side 253. The interconnection may be established by one or more protrusions 255 of the corner element 116 engaging one or more grooves 165 of an edge element 114, and/or one or more protrusions 155 of the edge element 114 engaging one or more grooves 165 of a corner element 116.

In some examples, some or all of the protrusions 155, 255 may be comprised by or formed in the edge element 114 or respectively the corner element 115 itself. In alternative examples, some or all of the protrusion 155, 255 may be formed by separate connection elements. In further examples, some or all of the protrusions 155,255 are manufactured as separate connection elements, and later fixed to the edge element 114 or respectively the corner element 115, for example by pressing or gluing.

Between grooves and protrusion of corner elements and edge elements, a channel 510 may be provided. This channel 510 may form part of a fluid distribution network, which will be elaborated on further in conjunction with FIG. 8.

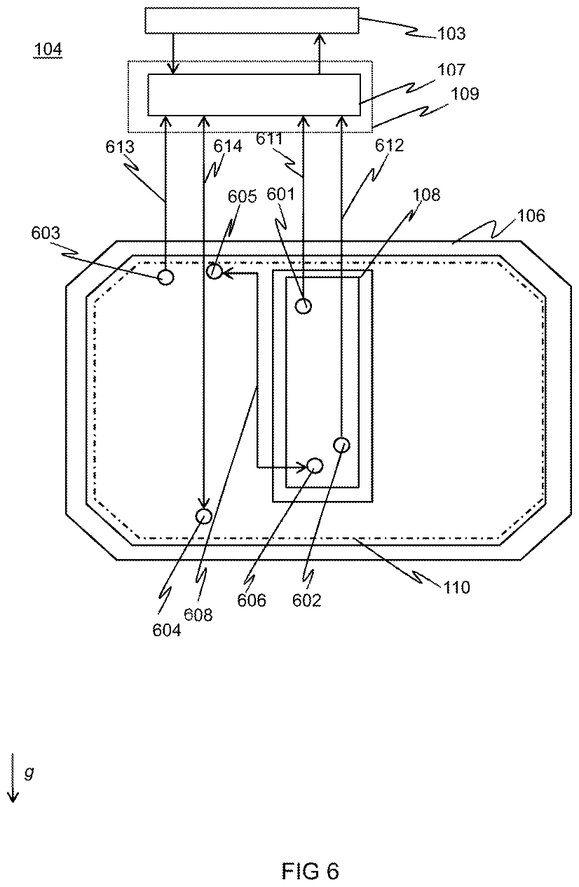

FIG. 6 shows a schematic cross-section of an example of the energy storage system 104, comprising the outer shell 106, inner shell 108 and liner module 110 (shown as dashed-dotted line). Gravity vector g indicates the direction of gravity in FIG. 6.

Schematically indicated in FIG. 6 are a first depth 601 and a second depth 602 inside the inner shell 108, wherein the first depth 601 lies higher with respect to gravity than the second depth 602. As stratification constitutes temperature differences in the fluid in the inner shell 108, when the first depth 601 is higher than the second depth 602, the fluid temperature at the first depth 601 may be higher than at the second depth 602.

As such, a fluid temperature around the first depth 601 may be higher than 80° C., or even higher than 90° C., and a fluid temperature around the second depth 602 may be lower than 90° C., or lower than 80° C. The fluid temperature may decrease when thermal energy is withdrawn from the energy storage system 104. Fluids with different temperatures may be used for different functions, for example heating of spaces in the dwelling 102, showering, cooking, and many different other functions.

In examples, the first depth 601 lies within the top half or even the top ⅓ of the inner shell 108, and the second depth 602 lies within the bottom half, or the bottom ⅔ of the inner shall 108.

Inside the liner module 110, an optional third depth 603 and a fourth depth 604 are indicated. The optional third depth 603 is provided higher than then fourth depth 604, and as such a fluid temperature at the third depth 603 may be higher than a fluid temperature at the fourth depth 604.

When the inner shell 108 is used for storing high temperature fluid, the fluid temperature may decrease from the first depth 601, to the second depth 602, to the third depth 603, with the fluid temperature around the fourth depth 604 being lowest.

The first depth 601 may substantially correspond to the third depth 603, albeit that they are respectively provided in the inner shell 108 and outside the inner shell 108.

In this example, the energy transfer module 109 comprises a first conduit 611 providing a fluid connection between the first depth 601 inside the inner shell 108 and a port module 107, a second conduit 612 providing a fluid connection between the second depth 602 inside the inner shell 108 and the port module 107, a third conduit 613 providing a fluid connection between the third depth 603 inside the liner module 110 and the port module 107, and a fourth conduit 614 providing a fluid connection between the fourth depth 604 inside the liner module 110 and the port module 107. Any of these fluid connections may be a one-way connection or a two-way connection.

The energy transfer module 109 as schematically shown in FIG. 6 may comprise one or more pumps for forcefully displacing fluid through one or more of the conduits.

In the energy transfer module 109, thermal energy may be extracted from fluid originating from the inner shell 108 and/or the liner module 110. To maintain a constant or substantially constant total fluid volume inside the energy storage system 104, fluid is returned to the energy storage system 104 when fluid is extracted from the storage system 104 for extracting thermal energy. Fluid may be returned at the fourth depth 604, i.e. in the coolest region of the energy storage system.

Next to extracting thermal energy from a fluid, the energy transfer module 107 may be further arranged for providing thermal energy to a fluid in the inner or outer shell, for example using solar collector 103 and/or electric heaters. It may be advantageous to provide thermal energy to fluid at the fourth depth 604 in the liner module 110 if the fluid has a low or the lowest temperature of the fluid inside the energy storage system 104. With this low temperature, more thermal energy may be stored in the fluid and thus in the energy storage system 104. Thermal energy transfer through conduction is proportional to the temperature difference between the media between which energy is transferred. With the cool or coolest fluid, this temperature difference may be optimised.

As a further option, the energy storage system 104 of FIG. 6 comprises a fluid transfer module 162 for allowing fluid transfer between a first transfer location 605 inside the liner module 110 and a second transfer location 606 inside the inner shell 108. The fluid transfer module 162 may be provided with a pumping device for creating a forced fluid flow through the transfer module 162 from the first transfer location 163 to the second transfer location 164.

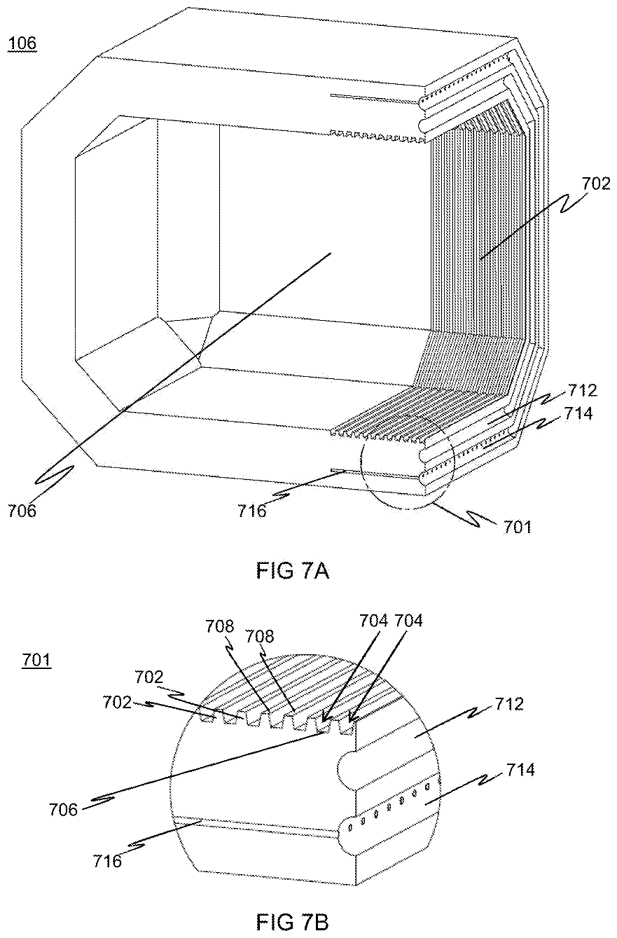

FIG. 7A shows a quarter section of an example of an outer shell 106 of the energy storage system 104. The outer shell 106 is at an inner surface 706 provided with a plurality of ridges 702 and grooves 704. In FIG. 7A, only part of the inner surface 706 of the outer shell 106 is shown with ridges and grooves. However, examples are envisioned wherein the entire inner surface 706 is provided with ridges 702, or at least a substantial part, for example more than 40%, more than 50%, more than 75%, even more than 80%, or even more than 90% of the inner surface 706 is provided with ridges.

The ridges 702 are in FIG. 7A shown as substantially parallel ridges 702, of which at least part of the plurality of ridges 702 is oriented vertically in use. Alternatively, or additionally, ridges 702 may be provided oriented for example perpendicular to other ridges 702, or in any other direction.

Indicated with a circle with reference numeral 701 is a detail of FIG. 7A, which detail 701 is shown in FIG. 7B.

In FIG. 7B, ridges 702 are visible, and only two ridges 702 are provided, with a reference numeral for clarity of the figure. By virtue of the ridges 702 protruding from the inner surface 706 of the outer shell 106, inter-ridge grooves 704 are provided.

The ridges 708 may comprise the same material or materials as the outer shell 106. Alternatively, the ridges 708 may be formed from a different material or different materials than the outer shell 106. These different materials may be chosen with certain material parameters in mind, such as a higher thermal resistance and/or a lower or higher stiffness.

The ridges 708 as shown in FIG. 7B comprise a top surface 708. When an energy storage system 104 comprises a liner module 110, the liner module 110 may abut top surfaces 708 of some or all of the ridges 702. When the liner module 110 comprises a flexible or elastic material, and the liner module 110 is filled with fluid, parts of the liner module 110 may protrude into the inter-ridge grooves 704.

The ridges 702 as shown in FIG. 7B are substantially trapezoid-shaped in their cross-section. However, in different examples, the cross section of the ridges 702 may be shaped different than a trapezoid, for example as a rectangle, square, triangle, or any other shape.

In examples, the surface area of the top surface 708 may be optimized. Either this surface area is kept as small as possible, to prevent transfer of thermal energy between the top surfaces 708 and the liner module 110, or this surface area is kept as large as possible, when the contact between the top surfaces 708 and the liner module 110 provides desired thermal insulation.

To prevent, or at least substantially prevent, parts of the liner module 110 from protruding into the inter-ridge spaces 704, the liner module 110 may comprise an inner liner element and an outer liner element surrounding at least part of the inner liner element. In such examples, the inner liner element is arranged for containing the second volume of fluid, and the outer liner element is arranged to constrain the volume of the inner liner element.

The outer liner element may substantially completely surround the inner liner, or may only surround part of the inner liner. For example only from the sides, or from the sides and the bottom. Furthermore may the outer liner element only be provided for parts of the liner module 110 which can abut ridges 702.

The outer liner element may comprise fibres, may be woven, and is arranged to provide tensile strength. By using an inner liner element and an outer liner element, the inner liner element may be made as fluid-tight as possible, whereas the outer liner element may provide the tensile strength to prevent rupture of the inner liner element due to weight of the second of volume of fluid.

When the outer liner element comprises fibres which provide tensile strength, these fibres may be oriented substantially perpendicular to the orientation of the ridges 702 to further prevent or substantially prevent the liner module 110 from protruding into the inter-ridge spaces 704.

Preferably, the inner liner element contains no or as few as possible seams or joints, as any seam or joint may provide a leakage risk. As such, the inner liner element may be blow-moulded.

When the outer liner element is arranged to contain a smaller volume than the inner liner element, the inner liner will not reach full volume and thus the chance of a rupture may be decreased.

Optionally, between the outer shell 106 and the liner module 110, a radiation barrier may be provided. This radiation barrier is arranged to substantially prevent transfer of thermal energy by virtue of radiation through said radiation barrier. Conduction and/or convection through the barrier may however still occur. With the radiation barrier provided between the liner module and the outer shell, the thermal resistance between the liner module and the outer shell may be increased.

In an example, the liner module comprises the radiation barrier. As such, the liner module may be arranged as the radiation barrier itself. When optionally present, any one of or both the outer liner module and the inner liner module may comprise the radiation barrier.

The radiation barrier may for example be formed by a radiation reflecting foil. Preferably the radiation reflecting foil is oriented with the radiation reflecting side away from the outer shell, i.e. in use towards the fluid.

The example of the outer shell 106 further shows an inner fluid channel 712 and an outer fluid channel 714 provided in the outer shell 106 as part of a fluid distribution network. Provided in fluid connection with the outer fluid channel 714 are optional auxiliary channels 716. The inner fluid channel 712, outer fluid channel 714, and/or auxiliary channels 716 are an option for examples on an outer shell 106, and may be provided also in examples where the ridges 702 are not provided.

One or both of the inner fluid channel 712 and the outer fluid channel 714 may be provided along the entire cross-section of the outer shell 106. The inner fluid channel 712, outer fluid channel 714, and auxiliary channels 716 will be elaborated on further in conjunction with FIG. 8.

FIG. 8 shows a cross-section of part of an example of an outer shell 106, comprising the inner fluid channel 712, as an example of a passage through the outer shell 106, provided at an inner side 802 of the outer shell 106, and the outer fluid channel 714, as an example of a passage through the outer shell 106. Provided in fluid connection with the outer fluid channel 714 is a plurality of auxiliary fluid channels 716, which are preferably spaced apart with a substantially constant spacing.

In examples, the spacing between the auxiliary fluid channels 716 is smaller or at least equal to a distance between the outer side 801 and the outer fluid channel 714, a distance between the outer fluid channel 714 and the inner fluid channel 712, and/or a distance between the inner fluid channel 712 and the top surface 706.

The cross-section as shown in FIG. 8 may be present in examples of plate elements 112, and in examples of perimeter elements such as the edge elements 114 and corner elements 116. The inner fluid channel 712, the outer fluid channel 714 or an auxiliary fluid channel 716 may be, at least partially, formed by the space 510 between a protrusion 155, 255 and a groove 156, 256 of a perimeter element, as indicated for example in FIG. 5A.

In the example shown in FIG. 8, at the inner side 802 of the outer shell 106, ridge 702 is provided, protruding from inner surface 706 of the outer shell 106 and forming top surface 708. When a liner module 110 is provided, the liner module 110 may abut this top surface 708.

As shown in FIG. 8, a space is enclosed by groove 704 and the liner module 110 abutting top surface 708 of the ridge 702. As such, the groove 704 may form part of the fluid distribution network, which is in examples comprised by the energy storage system 104.

Shown as wavy line 722 is an air flow, which may flow through the outer fluid channel 714. Shown as wavy line 724 is a return air flow, which may flow through the inner fluid channel 712. Shown as wavy line 726 is a high temperature air flow, which may flow through the groove 704. One or more of these air flows may be fluidly connected to one or more ventilation ports 810.

In further examples, any number of additional channels may be provided through the outer shell 106, next to or instead of one or more of the inner fluid channel 712, the outer fluid channel 714 and the auxiliary fluid channel 716.

The auxiliary channels 716 are an example of a slatted passage, and may be shaped with a circular cross-section. Alternatively, the auxiliary channels 716 may show cross-sections with a different shapes, such as for example a rectangular or square shape. The cross-section, may not be constant, and may as such be tapered towards or away from the outer fluid channel.

By virtue of the fluid distribution network, fluid flows, such as air flows, may be passed along and/or through the outer shell 106. These fluid flows may be used to withdraw moisture and/or condensation from the outer shell 106 and/or the liner module 110 if present. Moisture may seep into the outer shell 106 at the outer side 801, as soil surrounding the outer shell 106 may contain water and/or other fluids. This water may penetrate through the outer shell 106 from the outer side 801.

If a fluid penetrates in or through the outer shell 106 from the outer side 801, it may in examples first encounter the outer fluid channel 714 and the fresh air flow 722. At least part of the fluid may then be absorbed into the fresh air flow 722 and removed from the outer shell 106.

In practice, the temperature of the liner module 110 and/or fluid between the liner module 110 and the outer shell 106 may be higher than the temperature of the inner surface 706 of the outer shell 106. This may cause water to condensate on to the inner surface 706 of the outer shell 106. The high temperature air flow 726 may aid in transporting at least part of the condensate away from the outer shell 106, and for example even outside the energy storage system 104.

When passing through the groove 704, the air flow 726 may extract thermal energy from the liner module 110, by virtue of convection, conduction and/or radiation. As such, the temperature of the high temperature air flow 726 may be increased up to a temperature where it may be used for heating spaces in the dwelling 102. A ventilation port to which the high temperature air flow 726 is connected may thus form an output port for retrieving energy from energy storage system.

It will be appreciated that the fluid distribution network may be arranged for distribution of different types of fluids, and that fluids may comprise matter in liquid state, gas state or a mix thereof.

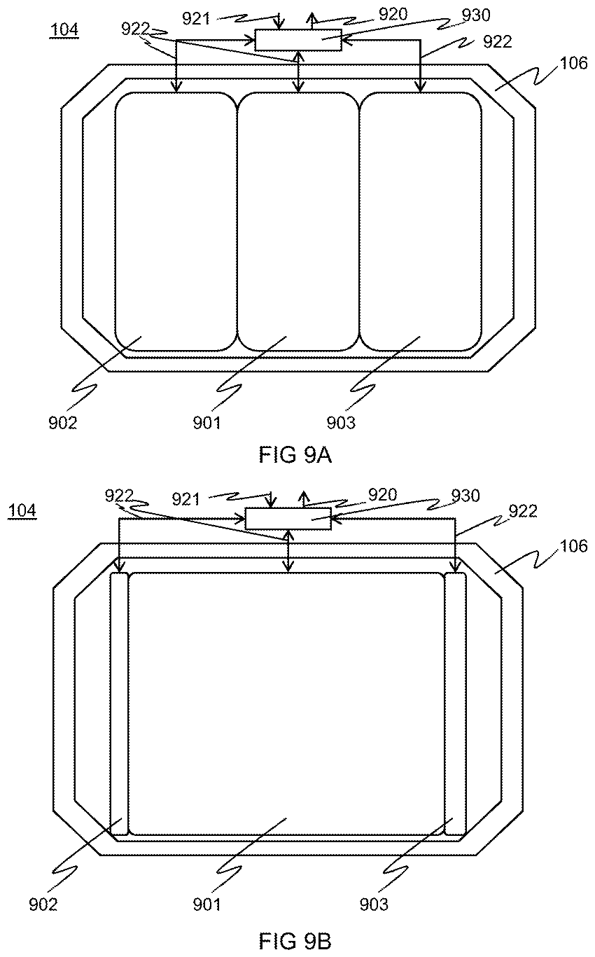

FIG. 9A and FIG. 9B show an example of an energy storage system 104, comprising an outer shell 106 defining an outer shell volume for holding a volume of fluid. The system 104 is arranged for storing thermal energy in a fluid within the outer shell 106. The system 104 is further arranged for converting between chemical energy of fluid stored in the energy storage system and electrical energy. Hence the energy storage system 104 can store thermal energy as well as electrical energy—in particular in the same fluid. That is, the energy storage system 104 can be charged by converting electrical energy into chemical energy, and can be discharged by converting the chemical energy into electrical energy.

In this example of the energy storage system 104 is provided in the outer shell 106 a first separated volume 901, a second separated volume 902, and a third separated volume 903.

In FIG. 9A, the energy storage system 104 is shown in a first state, which may be a charged state or a discharged state, wherein the first separated volume 901 is smaller than in the second state of the energy storage system 104, as shown in FIG. 9B.

From the examples shown in FIGS. 9A and 9B, it becomes apparent that the separated volumes may change in size, according to a state of charge of the electrical state of charge corresponding to an amount of electrical energy that can be withdrawn from the energy storage system 104. If the electrical energy may be obtained from a process in which chemical energy of a fluid stored in the energy storage system 104 is converted into electrical energy, the state of charge of the energy storage system 104 may correspond to an amount of chemical energy stored in the storage system 104.

When an example of an energy storage system 104 comprises three or more separated volumes, a first separated volume may be arranged to comprise freshwater, a second separated volume may be arranged to comprise salt water, and a third separated volume may be arranged to comprise a mix of the freshwater and the salt water.

By providing electrical energy to an input port of the energy storage system 104, the mixed water may be split into freshwater and salt water. For discharging the energy storage system 104, the energy transfer module may comprise an energy conversion module wherein freshwater and salt water can be mixed into mixed water, and as such chemical energy is converted to electrical energy which may be outputted via an output port of the energy storage system.

In another example of an energy storage system comprising three or more separated volumes, a first separated volume may be arranged to comprise water containing a salt, a second separated volume may be arranged to comprise an acidic fluid, and a third separated volume may be arranged to comprise an alkaline fluid.

By providing electrical energy to an input port of the energy storage system 104, the water containing the salt may be split into an acidic fluid and an alkaline fluid. Hence the need for separated volumes which can change the volume of fluid contained. For discharging the energy storage system 104, the energy transfer module may comprise an energy conversion module wherein the acidic fluid and the alkaline fluid can be mixed back into water containing the salt, and as such chemical energy is converted to electrical energy which may be outputted via an output port of the energy storage system.

In other examples of the energy storage system 104, the energy storage system 104 may comprise any number of separated volumes, for example two, three, four or even more than four.

A volume being separated may imply that the separated volume is not provided in fluid connection with a further separated volume. Optionally, valves may be present between separated volumes.

When a separated volume is adjacent to another separated volume, for example the first separated volume 901 and the second separated volume 902, thermal energy may be transferred between the separated volumes. As such, a steady state situation may occur wherein the fluid in adjacent separated volume shows the same or substantially the same temperature at the same height.

The example of the energy storage system 104 of FIGS. 9A and 9B may be provided with an inner shell 108, which may be a separate volume next to the other separated volumes.

When an example of an energy storage system 104 comprises two or more separated volumes, a first of the separated volumes may be arranged to comprise an anolyte, and a second of the separated volumes may be arranged to comprise a catholyte, and as such the energy storage system 104 may comprise a redox flow battery.

A separated volume may be comprised by the liner module 110, which liner module 110 may thus comprise a plurality of separated volumes. Provided around the plurality of separated volumes may be an outer liner, the function of which is explained in conjunction with FIG. 7B. The plurality of separated volumes may be comprised by the inner liner.

To allow a separated volume to change the amount of fluid it can contain, at least part of the separated volume may comprise a flexible, elastic, and/or resilient material, the separated volume may be provided with additional material which may act as bellows.

For transporting fluids between separated volumes, and thus changing a volume ratio between separated volumes, a control system may be provided which may comprise a plurality of conduits 922, pumps and/or valves.

The examples of the energy storage system 104 as depicted in FIGS. 9A and 9B are provided with an electrochemical interaction module 930 as an energy conversion module, comprising an input port 921 for electrical energy and an output port 920 for electrical energy. In use, for example the input port 921 may be connected to PV panels as a source of electrical energy.

When electrical energy is provided to the electrochemical interaction module 930 via the input port 921, the electrochemical interaction module 930 may exchange fluids and/or other matter such as ions between the different separated fluid volumes 901, 902, 903 and as such the energy storage system 104 may be charges.

The electrochemical interaction module 930 may further withdraw fluid from one or more of the separated fluid volumes 901, 902, 903 for generating electrical energy which may be outputted via output port 920.

The electrochemical interaction module 930 may be provided outside the outer shell 106, for example in a building which is heated and/or supplied with electrical energy by the energy storage system. As such, when maintenance is due, the electrochemical interaction module 930 may be more easily reachable.

Herein, the invention is described with reference to specific examples of embodiments of the invention. It will, however, be evident that various modifications and changes may be made therein, without departing from the scope of the invention as defined by the claims. The specifications, drawings and examples are, accordingly, to be regarded in an illustrative sense rather than in a restrictive sense.

In examples of the energy storage system 104, a ratio between a circumferential distance spanned by two perimeter elements and the plate elements interconnecting the two perimeter elements is larger than 5%. This ratio depends on the number of plate elements provided, a thickness of the plate elements and how the perimeter elements are shaped. In further examples, the ratio may be larger than 10%, larger than 15%, larger than 20%, or even 25% or larger.

A circumferential distance may be a width, height or depth of the outer shell. Different ratios may be present for each of the height, depth and width. In other examples, the ratio for two or all of the height, depth and width is equal or substantially equal.

With an increasing ratio, a cross-sectional shape of the outer shell 106 may more and more resemble an ovoid or sphere, which may contribute to the strength of the outer shell 106, for example to resist outside pressures, and may be beneficial against heat loss.

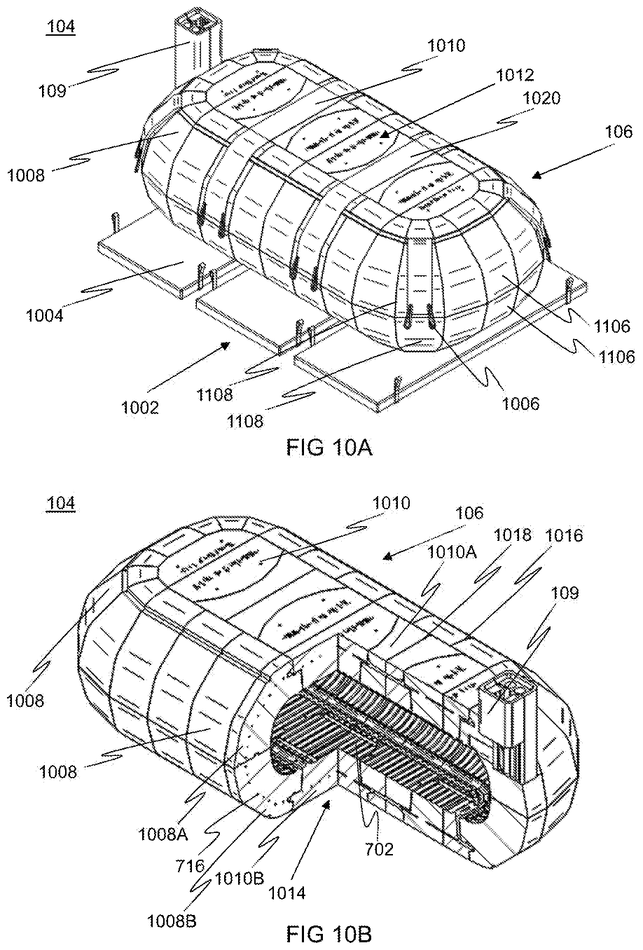

FIG. 10A depicts another example of an energy storage system 104. FIG. 10B depicts the example in a partially opened-up view. The energy storage system 104 comprises an outer shell 106 and an energy transfer module 109 with at least one input port for providing energy to the energy storage system and at least one output port for retrieving energy from energy storage system. When the energy storage system 104 comprises a fluid distribution network, the energy transfer module 109 may further comprise a separate fluid inlet and a separate fluid outlet for respectively providing and receiving a fluid flow, for example an air flow, to and from the energy transfer module 109.

In this particular example, as an option which may also be applied in other examples of the energy storage system 104, the outer shell comprises a plurality of interconnected modular elements. In particular, the outer shell 106 comprises a plurality of thermally insulating interconnected modular elements which may form a thermally insulating wall.

As an even further option, which may also be applied to other embodiments of energy storage systems, the energy storage system 104 of FIG. 10A is placed on a foundation 1002 for supporting the energy storage system 104, for example when the energy storage system 104 is placed under ground or above ground. A method for creating an underground thermal energy storage system 104 may hence comprise a step of placing a foundation underground, and subsequently placing the energy storage system on the underground foundation.

As an example, the foundation 1002 comprises a plurality of plates 1004, which may for example prevent the energy storage system 104 from sinking further into the ground and/or prevent the energy storage system 104 from floating up for example due to the presence of groundwater around the energy storage system. As such, the plates 1004 may extend beyond the energy storage system 104 in a plane at least partially perpendicular to gravity, which allows the plates 1004 to act as an anchor.

One or more bands or straps 1020 may be used for connecting the outer shell 106 to the foundation 1002. The bands or straps 1020 are preferably wide hands or straps, to prevent the bands or straps 1020 from exerting a high pressure on the outer shell, which may otherwise deform the outer shell. For example, a width of band or strap 1020 may be at least 20% or even at least 50% of the width of a perimeter element.

A band or strap 1020 may comprise a ground anchor connector 1006 for connecting the outer shell 106 to a ground anchor and/or the foundation 1002. By virtue of the connection with the ground anchor, one or more or all of the elements comprised by the outer shell 106 may be prestressed. A ground anchor may also screwed into the ground, and one or more bands or straps 1020 may be connected to such a ground anchor.

When the outer shell 106 is at least partially covered with soil, the weight of the soil pressing onto the outer shell 106 may provide prestressing of at least part of the outer shell 106. As such, when covered with soil, at least part of the outer shell 106 may be in a prestressed state in which at least part of the outer shell 106 has a higher resistance against forces, which forces may for example be caused directly or indirectly by weight of a fluid inside the outer shell and/or by vertical loads on the outer shell 106 for example by objects placed on top of the outer shell or on top of the ground under which the outer shell is placed.

In general, any plate element and perimeter element may be prestressed. For example, one or more tendons may be embedded in or connected to a plate element and/or perimeter element. By tensioning the tendon, the plate element and/or perimeter element may become prestressed. As such, an outer shell may in general comprise at least one prestressed plate element and/or at least one prestressed perimeter element.

In the partially opened-up view of FIG. 10B, the inside of the outer shell 106 is partially visible. As an example, the outer shell 106 comprises a plurality of ridges 702 provided along at least part of an inner surface of the outer shell 106. Inside the outer shell, a liner module may be placed which is not shown in FIG. 10B for clarity of the figure. Between the liner module and the ridges of the outer shell 106, air may flow as an example of a fluid flowing through a fluid distribution system.

As may be seen in FIG. 10B, the outer shell 106 comprises a plurality of different types of elements. In particular, the outer shell 106 comprises a plurality of perimeter elements 1008, and a plurality of plate elements 1010. The perimeter elements 1008 are interconnected between the plate elements 1010.

In the particular example of FIGS. 10A and 10B, two perimeter elements may be interconnected between the plate elements 1010. For example, the perimeter elements are formed by a plurality of corner elements 1108 and edge elements 1106. The plate elements 1010 may form a ceiling 1012 of the energy storage system 104 and a bottom 1014 of the energy storage system 104, which ceiling 1012 and bottom 1014 may be substantially parallel to each other.

More in general, applicable to any example of the outer shell 106, a plate element may be interconnected with another plate element by one or more perimeter elements. In FIG. 10B, for example, a ceiling plate element 1010A is interconnected with a bottom plate element 1010B via an upper perimeter element 1008A and a lower perimeter element 1008B. The lower perimeter element 1008B and the upper perimeter element 1008A may be regarded as sub-elements of a single perimeter element, or may be regarded as two separate perimeter elements.

In general for any example of the outer shell, when seen in a cross-sectional view in a plane parallel to gravity, the outer shell may comprise in a clockwise or counter-clockwise direction: any number of plate elements, any number of perimeter elements, any number of plate elements and any number of perimeter elements. In the example of FIG. 10B, this corresponds to one ceiling plate element 1010A, two perimeter elements, one bottom plate element 1010B, and two perimeter elements 1008B and 1008A.

Alternatively, when seen in a cross-sectional view in a plane parallel to gravity, the outer shell may comprise in a clockwise or counter-clockwise direction: any number of plate elements, for example forming part of a ceiling, any number of perimeter elements, any number of plate elements, for example forming part of a side wall perpendicular to the ceiling, any number of perimeter elements, any number of plate elements, for example forming part of a bottom, any number of perimeter elements, any number of plate elements, for example forming part of another side wall perpendicular to the bottom, and any number of perimeter elements, as for example shown in FIG. 3.

A perimeter of the outer shell 106 formed by the perimeter elements connects the ceiling 1012 and the bottom 1014. In particular, the perimeter may be formed by adjacent sets of edge elements 1106 and corner elements 1108. A set of edge elements 1106 may comprise a lower edge element 1008B and an upper edge element 1008A, and may provide a substantially 180 degrees turn in a single plane, whereas a set of corner elements 1108 may provide a substantially 180 degrees turn in a first plane, and also a turn in plane substantially parallel to the bottom 1012 and/or the ceiling 1014.

For example, when three sets of corner elements 1108 are used to form a corner of the outer shell, the turn in the plane substantially parallel to the bottom 1012 and/or the ceiling 1014 may be 30 degrees—which corresponds to 90 degrees divided by the number of sets of corner elements 1108 used. In other words, a corner element may allow two adjacent perimeter elements to be positioned at a particular angle relative to each other. An edge element may allow two adjacent perimeter elements to be positioned parallel to each other.

In general, it may be understood that one or more perimeter elements allow plate elements to be positioned in a particular orientation relative to each other. For example, in the embodiment of FIG. 3, an edge element 114 allows two plate elements to be positioned at an angle of substantially 90 degrees relative to each other. In another example, for example shown in FIG. 10A, a set of perimeter elements allows two plate elements to be positioned substantially parallel to each other, albeit positioned upside-down relative to each other.

It may be understood from FIG. 10B that embodiments of an energy storage system 104 without the inner shell 108 are also envisioned. Any feature disclosed in conjunction with the inner shell 108, such as the use of one or more spirals, the effect of stratification, conduits at different depths, and any other feature may be readily applied to at least one of the outer shell and the liner module.

One or more auxiliary fluid channels 716 may be present through one or more of the perimeter elements and plate elements, forming part of the fluid distribution network. For example, by providing a flow of air as fluid through the one or more auxiliary fluid channels 716, moisture may be withdrawn from the outer shell for drying the outer shell.

It may be preferred to misalign one or more seams 1016 between perimeter elements and one or more seams 1018 between one or more adjacent plate elements. This may be beneficial to the structural integrity of the outer shell. As may be seen in FIG. 10B, a particular plate element 1010A may be interconnected with more than one perimeter element. Such a plate element may comprise one or more fanned out sections and/or tapered sections. The fanned out section or sections may abut more than one perimeter element, for example two perimeter elements. When removing one or more plate elements, for example a ceiling element, for example for accessing the outer shell volume for maintenance, all perimeter elements may remain interconnected between plate elements by virtue of the fanned out section or sections.

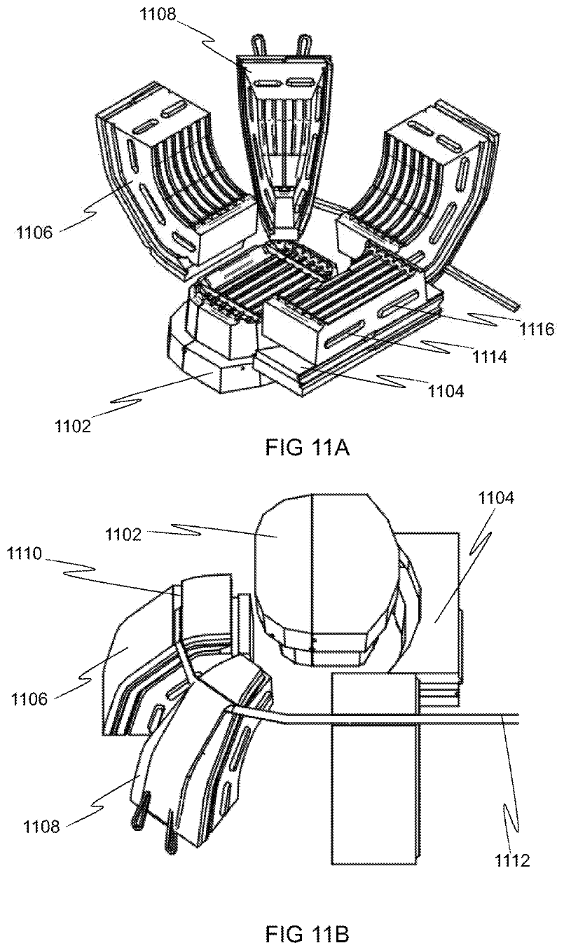

FIG. 11A and FIG. 11B depict an exploded view of part of an example of an energy storage system. In particular, two plate elements and three perimeter elements are depicted. In general, an energy storage system may comprise any number of plate elements, and any number of perimeter elements.

In particular, a first of the plate elements is a convex plate element 1102. A second of the plate elements is a concave plate element 1104. In general, a convex plate element 1102 may be interconnected with a concave plate element 1104 to form a combined plate element. The convex plate element 1102 may comprise multiple sub-elements, for example two convex sub-elements.

The exploded views of FIGS. 11A and 11B further show two edge elements 1106 and one corner element 1108 as examples of perimeter elements. As an option, the edge element 1106 and the corner element 1108 comprise an outer groove 1110 for accommodating a tensioning band 1112 which may be comprised by a tensioning module.

As a further option, one or both of the plate elements and the perimeter elements depicted in FIGS. 11A and 11B may comprise one or more protrusions 1116 and grooves 1114—similarly as explained in conjunction with FIG. 5A.

In general, and applicable to all embodiments of the energy storage system, adjacent perimeter elements and/or plate elements may be connected to each other using a glue. A method of creating or assembling a thermal energy storage system may hence comprise gluing one or more adjacent perimeter elements and/or plate elements onto each other.

Depending on the available size of molds from which the modular elements may be manufactured, in general, one more of the modular elements shown in the figures may be combined into a single element. For example, a set of edge elements and/or set of corner elements shown in FIG. 10A may be manufactured as a single substantially C-shaped element.

As an option, a thermal energy storage system may comprise a fluid distribution network, which may for example be comprised by the outer shell. The fluid which may be distributed through the fluid distribution network may be a different type of fluid than the fluid used to storage thermal and/or chemical energy in. It will be appreciated that a fluid may comprise matter in liquid state, gas state or a mix thereof.

In a particular example, water as a fluid is used for storing thermal energy therein. The water may be held in a liner module, anti/or an inner shell. As another example which may be readily combined with other examples, the fluid distributed through the fluid distribution network may he air. Air may comprise a particular amount of water vapor, which may be expressed as a relative humidity. The skilled person will appreciate that relative humidity depends on the temperature of the air.

The energy transfer module may be arranged for providing an air flow through the fluid distribution network of the outer shell, and may for example comprise one or more air flow devices such as fans or pumps for constituting an air flow through the fluid distribution network.

The air may for example originate from a dwelling or another building, in particular any building which may be provided with thermal energy from the energy storage system. Typically, the air from the dwelling may be relatively dry compared to air outside the dwelling. Furthermore, the temperature of air from the dwelling may be higher than the temperature of air outside the dwelling.

By virtue of the fluid distribution network, as explained above, a relatively dry outer shell may be obtained underground. When the outer shell is relatively dry, the thermal insulation of the outer shell may improve compared to a relatively moist outer shell. Typically, soil covering the outer shell is moist, for example due to rain and/or groundwater. The outer shell may at its outer surface be at least partially permeable to moisture from the soil, which may hence enter into the outer shell. By virtue of distributing the fluid such as air through the fluid distribution network, the moisture entered may be removed from the outer shell.

The fluid, such as the air, may thus enter the fluid distribution network with an inlet temperature and an inlet humidity. When traveling through the fluid distribution network, the temperature of the air may increase by virtue of heat transfer from the fluid in which thermal energy is stored to the air. When the temperature of the air increase, its relative humidity may typically decrease. Water present in or on the outer shell. and/or other parts inside the outer shell may be transferred into the flow of air. At the end of the fluid distribution network, the air has an outlet temperature and an outlet humidity, which may both be higher than the inlet temperature and the inlet humidity. The air exiting the fluid distribution network, for example via the energy transfer module, may as an option be expelled back into the dwelling for example for heating the dwelling.

Optionally, one or more heat exchangers may be used for exchanging thermal energy between air in the dwelling and air flowing into and/or out of the fluid distribution network.

By virtue of the fluid distribution network, hence, a relatively dry environment may be obtained underground in the outer shell. The outer shell may comprise a storage compartment for storing components which are preferably stored in a dry environment. The storage compartment may be positioned inside the outer shell but outside the liner module. For example, one or more electrical components, batteries, fuse boxes, converters, inverters, heat pumps, any other component or any combination thereof may be stored in the storage compartment. In particular, thermal energy generated by one or more of the electrical components may be extracted by a fluid flow through the fluid distribution network. As such, the fluid flow may provide necessary cooling to the electrical components which may otherwise overheat in a thermally insulated environment, for example an underground environment.

The storage compartment may in particular be used for storing a heat pump, which may be provided with a separate air inlet and outlet to an outside of the dwelling. The storage compartment may be substantially sound insulating, in particular when placed underground, and may hence reduce unwanted noise generated by the heat pump from being heard inside and/or outside the dwelling or other building.

As a particular option, the storage compartment may be accessible for a person, for example through an access point inside or outside the dwelling. Access may be useful for example for maintenance of the components stored in the storage compartment. Alternatively or additionally, the storage compartment or at least part thereof may be lifted out of the outer shell, for example for maintenance.

The fluid distribution network may be provided at least partially along the storage compartment for drying and/or heating the storage compartment.

A method is hence envisioned for extracting moisture and/or thermal energy from an energy storage system, in particular an underground energy storage system comprising an outer shell defining an outer shell volume and provided with a fluid distribution network. The method comprises circulating a fluid such as air through the fluid distribution network and storing thermal energy in a separate fluid in the outer shell. In particular, the temperature of at least part of the separate fluid may be higher than the temperature of the fluid entering the fluid distribution network.

As an option, the method may comprise providing air from a dwelling for circulating through the fluid distribution network. As a further option, the method may comprise providing circulated air back into the dwelling, preferably with at least one of a higher temperature and higher relative humidity than the air entering the fluid distribution network. As a result of the method, a moisture content of the outer shell may decrease as moisture is extracted from the outer shell by virtue of the air flowing into, through and out of the fluid distribution network.

For the purpose of clarity and a concise description features are described herein as part of the same or separate examples, however, it will be appreciated that the scope of the invention may include embodiments having combinations of all or some of the features described without departing from the scope of the invention as defined by the claims.

In the claims, any reference sign placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. Thermal energy storage system, comprising:
an outer shell defining an outer shell volume;
an energy transfer module, comprising:
an input port for providing energy to the energy storage system;
an output port for retrieving energy from energy storage system;
wherein the outer shell is provided with a fluid distribution network.

2. The thermal energy storage system according to claim 1, wherein the fluid distribution network is arranged for ventilating the outer shell.

3. The thermal energy storage system according to claim 1, wherein the outer shell comprises a thermally insulating wall.

4. The thermal energy storage system according to claim 1, wherein the energy transfer module is arranged for providing a fluid flow through the fluid distribution network of the outer shell.

5. The thermal energy storage system according to claim 1, further comprising a liner module, arranged for holding a volume of fluid, wherein the liner module is provided in the outer shell.

6. The thermal energy storage system according to claim 5, further comprising:
a plurality of ridges and grooves provided along at least part of an inner surface of the outer shell,
wherein an outer surface of the liner module is arranged to abut the ridges and a space enclosed by the grooves and the liner module forms part of the fluid distribution network.

7. The thermal energy storage system according to claim 6, wherein the ridges are oriented substantially parallel to each other.

8. The thermal energy storage system according to claim 1, wherein the outer shell comprises a plurality of passages through the outer shell, which plurality of passages forms part of the fluid distribution network of the outer shell.

9. The thermal energy storage system according to claim 1, wherein the outer shell comprises a plurality of plate elements, and a plurality of perimeter elements interconnected between the plate elements.

10. The thermal energy storage system according to claim 9, wherein the outer shell comprises a plurality of passages through the outer shell, which plurality of passages forms part of the fluid distribution network of the outer shell and wherein the plate elements comprise a slotted passage as part of the plurality of passages through the outer shell.

11.-14. (canceled)

15. The thermal energy storage system according to claim 9, wherein a ratio between a circumferential distance spanned by two perimeter elements and a circumferential distance spanned by the plate elements interconnecting the two perimeter elements is larger than 5%.

16. The thermal energy storage system according to claim 9, wherein the outer shell comprises a tensioning module arranged to tension the plurality of interconnected perimeter elements and plate elements towards each other.

17. The thermal energy storage system according to claim 9, wherein the plurality of perimeter elements comprises:
one or more edge elements; and/or
one or more corner elements.

18. The thermal energy storage system according to claim 1, including an inner shell defining an inner shell volume within the outer shell volume, and arranged for holding a volume of fluid.

19. (canceled)

20. The thermal energy storage system according to claim 18, further comprising a liner module, arranged for holding a volume of fluid, wherein the inner shell is provided in the liner module.

21.-48. (canceled)

49. The thermal energy storage system according to claim 1, wherein the outer shell has an inner fluid channel and an outer fluid channel provided in the outer shell as part of the fluid distribution network.

50. The thermal energy storage system according to claim 9, wherein the plurality of plate elements and perimeter elements form a rectangular shape and wherein one or more of the edges and corners of the rectangular shape are non-straight edges and corners.

51. The thermal energy storage system according to claim 1, wherein the storage system is arranged as an underground energy storage system.

52. Method for creating an underground thermal energy storage system, comprising:
providing a thermal energy storage system according to claim 51;
placing the energy storage system underground; and
surrounding the energy storage system with soil.

53. Method of ventilating an underground thermal energy storage system, comprising:
providing an underground thermal energy storage system according to claim 51; and
withdrawing moisture from the outer shell of the underground thermal energy storage system by providing a fluid flow through the fluid distribution network of the outer shell.
